(19) United States
(12) Patent Application Publication
(10) Pub. No.: US 2025/0214534 A1
(43) Pub. Date: Jul. 3, 2025

(54) VEHICLE CONTROL SYSTEM AND CONTROL METHOD

(71) Applicant: Panasonic Automotive Systems Co., Ltd., Kanagawa (JP)

(72) Inventor: Naoya TANIMURA, Kanagawa (JP)

(73) Assignee: Panasonic Automotive Systems Co., Ltd., Kanagawa (JP)

(21) Appl. No.: 18/986,991

(22) Filed: Dec. 19, 2024

(30) Foreign Application Priority Data
Dec. 27, 2023 (JP) 2023-220784

(51) Int. Cl. B60R 25/30; G07C 5/00; G07C 5/08

(52) U.S. Cl. CPC B60R 25/30; G07C 5/008; G07C 5/0808

(57) ABSTRACT

A vehicle control system includes: an obtainer that obtains vehicle information on a vehicle from an in-vehicle network; a communicator that is capable of communicating with an external device via an external network and transmits the vehicle information obtained by the obtainer to the external device via the external network; an anomaly detector that detects a security anomaly in the in-vehicle network; and a controller that restricts communication between the communicator and the external device when the security anomaly is detected by the anomaly detector.

### CROSS REFERENCE TO RELATED APPLICATION

The present application is based on and claims priority of Japanese Patent Application No. 2023-220784 filed on Dec. 27, 2023.

### FIELD

The present disclosure relates to a vehicle control system and a control method.

### BACKGROUND

A vehicle control system that establishes an in-vehicle network provided in a vehicle is known. In recent years, there is a trend toward integrating large numbers of electronic control units (ECU) provided in in-vehicle networks in such vehicle control systems. In conjunction with this, there is also a trend in which advances are being made to move toward shared storage for sharing data between pluralities of ECUs. Accordingly, security technologies for detecting unauthorized access to such integrated storage are being proposed (see Patent Literature (PTL) 1, for example).

### CITATION LIST

### Patent Literature

PTL 1: Japanese Patent No. 7246032

### SUMMARY

The above-mentioned conventional vehicle control system can be improved upon.

In view of this, the present disclosure provides a vehicle control system and a control method that can further improve upon the related art.

A vehicle control system according to one aspect of the present disclosure is a vehicle control system that establishes an in-vehicle network provided in a vehicle, and the vehicle control system includes: an obtainer that obtains vehicle information on the vehicle from the in-vehicle network; a communicator that is capable of communicating with an external device via an external network and transmits the vehicle information obtained by the obtainer to the external device via the external network; an anomaly detector that detects a security anomaly in the in-vehicle network; and a controller that restricts communication between the communicator and the external device when the security anomaly is detected by the anomaly detector.

It should be noted that these generic or specific aspects may be implemented as a system, a method, an integrated circuit, a computer program, or a computer-readable recording medium, such as a compact disc-read only memory (CD-ROM), or may be implemented as any combination of a system, a method, an integrated circuit, a computer program, and a recording medium.

The vehicle control system and the like according to one aspect of the present disclosure can further improve upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating a configuration of a vehicle control system according to Embodiment 1.

FIG. 2 is a block diagram illustrating a functional configuration of a central ECU according to Embodiment 1.

FIG. 3 is diagram for describing an example of a function of the central ECU according to Embodiment 1.

FIG. 4 is a flowchart illustrating the flow of operation of the central ECU according to Embodiment 1.

FIG. 5 is a block diagram illustrating a functional configuration of a central ECU according to Embodiment 2.

FIG. 6 is a diagram for describing an example of a function of the central ECU according to Embodiment 2.

FIG. 7 is a flowchart illustrating the flow of operation of the central ECU according to Embodiment 2.

### DESCRIPTION OF EMBODIMENTS

### Underlying Knowledge Forming Basis of the Present Disclosure

In relation to the technique described in the “Background” section, the inventors have found the following point to be problematic.

The above-mentioned conventional vehicle control system includes a telematics control unit (TCU) that notifies an external server of a detection result when unauthorized access to storage is detected. However, in a case where an attacker steals a vehicle, for example, there is a risk that the attacker may access the TCU in an unauthorized manner, or that notification from the TCU to an external server may not be properly performed due to the TCU being physically modified in an unauthorized manner.

In order to overcome this problematic point, the inventors propose the vehicle control system and control method described hereinafter.

### Technique 1

A vehicle control system that establishes an in-vehicle network provided in a vehicle, the vehicle control system comprising: an obtainer that obtains vehicle information on the vehicle from the in-vehicle network; a communicator that is capable of communicating with an external device via an external network and transmits the vehicle information obtained by the obtainer to the external device via the external network; an anomaly detector that detects a security anomaly in the in-vehicle network; and a controller that restricts communication between the communicator and the external device when the security anomaly is detected by the anomaly detector.

According to Technique 1, when a security anomaly is detected by the anomaly detector, the controller executes a process to temporarily raise a security level of the in-vehicle network by restricting communication between the communicator and the external device. Accordingly, vehicle information or the like that an attacker has tampered with can be prevented from being transmitted from the communicator to the external device, for example. As a result, safety of communication between the communicator and the external device when a security anomaly is detected can be improved.

### Technique 2

The vehicle control system according to Technique 1, wherein when the security anomaly is detected by the anomaly detector, the controller filters a plurality of vehicle information items obtained by the obtainer to output, to the communicator, a specific vehicle information item among the plurality of vehicle information items, the plurality of vehicle information items each being the vehicle information, and the communicator transmits the specific vehicle information item output from the controller to the external device via the external network.

According to Technique 2, when a security anomaly is detected by the anomaly detector, the controller can effectively restrict communication between the communicator and the external device by filtering the plurality of vehicle information items obtained by the obtainer.

### Technique 3

The vehicle control system according to Technique 1, wherein the in-vehicle network is virtually divided into a plurality of virtual local area networks (VLANs), when the security anomaly is detected by the anomaly detector, the controller outputs, to the communicator, a specific vehicle information item from a specific VLAN among a plurality of vehicle information items from the plurality of VLANs obtained by the obtainer, the plurality of vehicle information items each being the vehicle information, and the communicator transmits the specific vehicle information item output from the controller to the external device via the external network.

According to Technique 3, when a security anomaly is detected by the anomaly detector, the controller can effectively restrict communication between the communicator and the external device by changing or adding VLAN settings.

### Technique 4

The vehicle control system according to any one of techniques 1 to 3, wherein when the security anomaly is detected by the anomaly detector, the controller determines a risk level indicating a degree of risk corresponding to the security anomaly detected, and restricts communication between the communicator and the external device, in stages, in accordance with the risk level determined.

According to Technique 4, the higher the risk level is, the more stringently communication between the communicator and the external device is restricted, thus making it possible to effectively improve the safety of communication between the communicator and the external device.

### Technique 5

The vehicle control system according to any one of techniques 1 to 4, wherein when a security anomaly caused by an unauthorized physical modification of the in-vehicle network is detected by the anomaly detector, the controller further (i) causes the vehicle to transition from a state in which the vehicle is drivable to a state in which the vehicle is undrivable or (ii) causes the vehicle to transition from a state in which an ignition can be turned on to a state in which the ignition cannot be turned on.

According to Technique 5, when a security anomaly caused by an unauthorized physical modification of the in-vehicle network is detected by the anomaly detector, the vehicle can be prevented from being stolen or being driven out of control, for example.

### Technique 6

A control method in a vehicle control system that establishes an in-vehicle network provided in a vehicle, the control method comprising: (a) obtaining vehicle information on the vehicle from the in-vehicle network; (b) transmitting the vehicle information obtained in (a) from a communicator of the vehicle control system to an external device via an external network; (c) detecting a security anomaly in the in-vehicle network; and (d) restricting communication between the communicator and the external device when the security anomaly is detected in (c).

According to Technique 6, when a security anomaly in the in-vehicle network is detected, a process is executed to temporarily raise the security level of the in-vehicle network by restricting communication between the communicator of the vehicle control system and the external device. Accordingly, vehicle information or the like that an attacker has tampered with can be prevented from being transmitted from the communicator to the external device, for example. As a result, safety of communication between the communicator and the external device when a security anomaly is detected can be improved.

It should be noted that these generic and specific aspects may be implemented as a system, a method, an integrated circuit, a computer program, or a computer-readable recording medium, such as a CD-ROM, or may be implemented as any combination of a system, a method, an integrated circuit, a computer program, and a recording medium.

Hereinafter, embodiments will be described in detail with reference to the drawings.

It should be noted that the embodiments described below merely illustrate general or specific examples of the present disclosure. The numerical values, shapes, materials, elements, the arrangement and connection states of the elements, steps, the order of the steps, etc., described in the following embodiments are mere examples, and are therefore not intended to limit the present disclosure. Accordingly, among elements in the following embodiments, those not appearing in any of the independent claims that indicate the broadest concepts of the present disclosure will be described as optional elements.

### Embodiment 1

### 1-1. Vehicle Control System Configuration

First, a configuration of vehicle control system 2 according to Embodiment 1 will be described with reference to

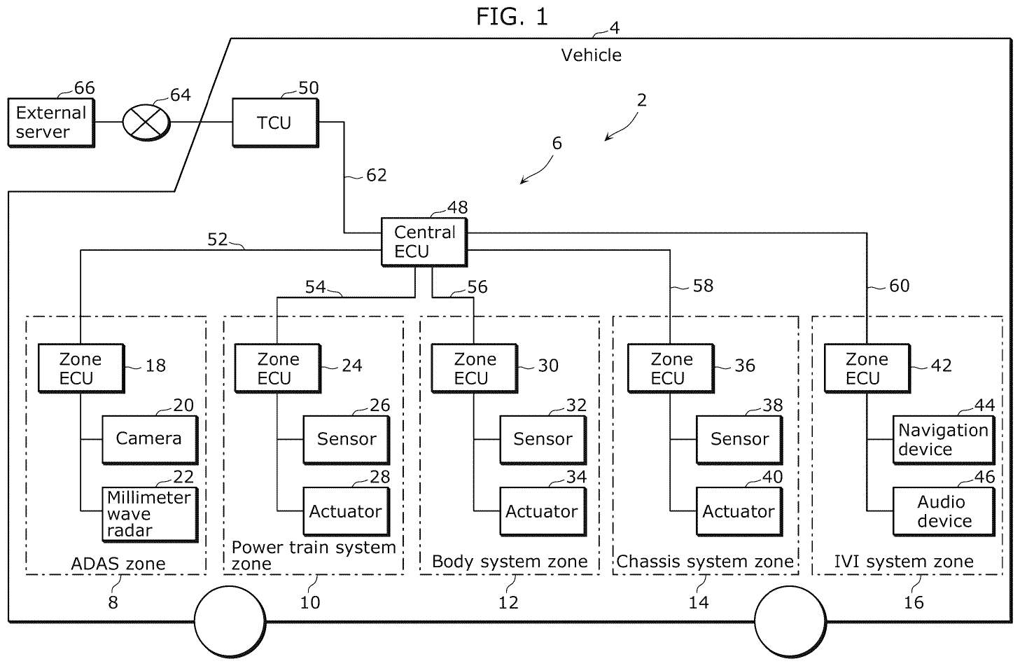

FIG. 1. FIG. 1 is a block diagram illustrating a configuration of vehicle control system 2 according to Embodiment 1.

As illustrated in FIG. 1, vehicle control system 2 according to Embodiment 1 is a system for controlling vehicle 4, which is an automobile or the like, and establishes in-vehicle network 6 provided in vehicle 4.

In-vehicle network 6 includes advanced driver assistance system (ADAS) zone 8, powertrain system zone 10, body system zone 12, chassis system zone 14, and in-vehicle infotainment (IVI) system zone 16, for example.

ADAS zone 8 includes zone ECU 18, camera 20, and millimeter wave radar 22, for example. Zone ECU 18 is an electronic control unit for controlling driving operations of vehicle 4 in an ADAS. Camera 20 captures images of the surroundings of vehicle 4. Millimeter wave radar 22 senses distances between vehicle 4 and target objects in the surroundings of vehicle 4. Zone ECU 18 drives a mechanism in a region in vehicle 4 allocated to zone ECU 18 according to an imaging result of camera 20, a sensing result of millimeter wave radar 22, and instructions from central ECU 48 (will be described later).

Powertrain system zone 10 includes zone ECU 24, sensor 26, and actuator 28, for example. Zone ECU 24 is, for example, an electronic control unit that performs control related to the driving of vehicle 4, such as control of a motor, fuel, battery, and the like. Zone ECU 24 drives a mechanism in a region in vehicle 4 allocated to zone ECU 24, by controlling actuator 28 according to a sensing result of sensor 26 and instructions from central ECU 48.

Body system zone 12 includes zone ECU 30, sensor 32, and actuator 34, for example. Zone ECU 30 is an electronic control unit for controlling functions provided in vehicle 4, such as those for door locks, power windows, air conditioners, lights, and turn signals of vehicle 4, for example. Zone ECU 30 drives a mechanism in a region in vehicle 4 allocated to zone ECU 30, by controlling actuator 34 according to a sensing result of sensor 32 and instructions from central ECU 48.

Chassis system zone 14 includes zone ECU 36, sensor 38, and actuator 40, for example. Zone ECU 36 is an electronic control unit for controlling behaviors of vehicle 4, such as “turning” and “stopping”, for example. Zone ECU 36 drives a mechanism in a region in vehicle 4 allocated to zone ECU 36, by controlling actuator 40 according to a sensing result of sensor 38 and instructions from central ECU 48.

IVI system zone 16 includes zone ECU 42, navigation device 44, and audio device 46, for example. Zone ECU 42 is an electronic control unit for controlling various information devices that present a variety of information to passengers of vehicle 4, for example. Navigation device 44 is an information device for navigating a route to a destination. Audio device 46 is an information device for playing back music recorded on a recording medium. Zone ECU 42 controls navigation device 44 and audio device 46 in accordance with instructions from central ECU 48.

In-vehicle network 6 further includes central ECU 48 and TCU 50 (an example of a communicator). It should be noted that vehicle control system 2 according to Embodiment 1 is implemented by central ECU 48 and TCU 50.

Central ECU 48 is connected to each of the plurality of zone ECUs, namely zone ECU 18, zone ECU 24, zone ECU 30, zone ECU 36, and zone ECU 42 via a plurality of buses, namely, bus 52, bus 54, bus 56, bus 58, and bus 60, and control each of zone ECU 18, zone ECU 24, zone ECU 30, zone ECU 36, and zone ECU 42. Furthermore, central ECU 48 is connected to TCU 50 via bus 62. It should be noted that each of bus 52, bus 54, bus 56, bus 58, bus 60, and bus 62 is a controller area network (CAN) bus, for example. Central ECU 48 obtains a plurality of vehicle information items from each of zone ECU 18, zone ECU 24, zone ECU 30, zone ECU 36, and zone ECU 42 in in-vehicle network 6, and outputs the plurality of vehicle information items obtained to TCU 50. It should be noted that vehicle information is information on vehicle 4, and is log information indicating the driving speed, driving distance, and the like of vehicle 4, for example.

Furthermore, central ECU 48 detects security anomalies in in-vehicle network 6. Here, “security anomaly” refers, for example, to (a) unauthorized access including prohibited control commands, (b) writing to prohibited addresses, and (c) detection of tampering by unauthorized physical modifications or the like. When a security anomaly is detected, central ECU 48 outputs a detection result to TCU 50.

Central ECU 48 is implemented by a program executor, such as a central processing unit (CPU) or a processor or the like reading and executing a computer program recorded on a recording medium, such as a hard disk or a semiconductor memory or the like. It should be noted that central ECU 48 may include an ether switch and/or a peripheral component interconnect express (PCIe) switch or the like for connecting the plurality of buses, namely, bus 52, bus 54, bus 56, bus 58, bus 60, and bus 62, for example.

TCU 50 is a wireless communication module capable of communicating with external server 66 (an example of an external device) via external network 64, which is the Internet or the like. TCU 50 transmits a plurality of vehicle information items output from central ECU 48 to external server 66 via external network 64. Furthermore, when a security anomaly is detected in in-vehicle network 6, TCU 50 transmits the detection result output from central ECU 48 to external server 66 via external network 64. Accordingly, external server 66 can analyze the security anomaly that has occurred in in-vehicle network 6.

Furthermore, in-vehicle network 6 is virtually divided into a plurality of virtual local area networks (VLANs), namely, first VLAN, second VLAN, and third VLAN, for example. The first VLAN includes ADAS zone 8, IVI system zone 16, and TCU 50. The second VLAN includes powertrain system zone 10 and chassis system zone 14. The third VLAN includes body system zone 12.

Although in the present embodiment, in-vehicle network 6 includes central ECU 48 and a plurality of zone ECUs, namely, zone ECU 18, zone ECU 24, zone ECU 30, zone ECU 36, and zone

ECU 42 that are connected to central ECU 48, this example is non-limiting. In-vehicle network 6 may, for example, include a gateway and a plurality of domain controllers connected to the gateway.

### 1-2. Functional Configuration of Central ECU

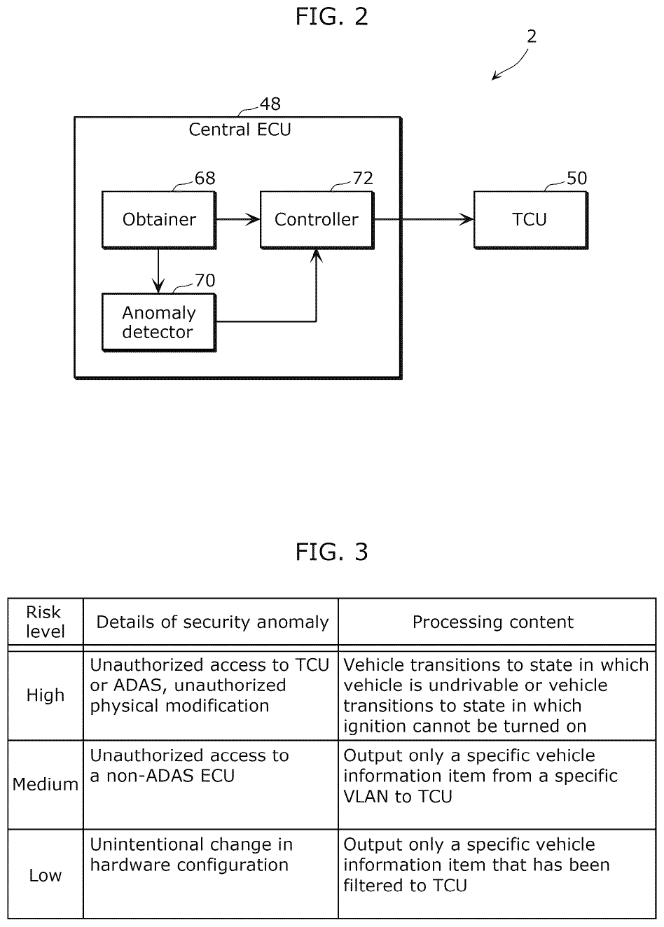

Next, a functional configuration of central ECU 48 according to Embodiment 1 will be described with reference to FIG. 2 and FIG. 3. FIG. 2 is a block diagram illustrating a functional configuration of central ECU 48 according to Embodiment 1. FIG. 3 is a diagram for describing an example of a function of central ECU 48 according to Embodiment 1.

As illustrated in FIG. 2, central ECU 48 includes obtainer 68, anomaly detector 70, and controller 72, as functional elements.

Obtainer 68 obtains a plurality of vehicle information items from each of zone ECU 18, zone ECU 24, zone ECU 30, zone ECU 36, and zone ECU 42 (see FIG. 1) in in-vehicle network 6.

Anomaly detector 70 detects security anomalies in in-vehicle network 6 based on the plurality of vehicle information items obtained by obtainer 68. When a security anomaly is detected in in-vehicle network 6, anomaly detector 70 outputs a detection result to controller 72.

When anomaly detector 70 does not detect a security anomaly, controller 72 outputs the plurality of vehicle information items obtained by obtainer 68 to TCU 50. Accordingly, TCU 50 transmits the plurality of vehicle information items output from controller 72 to external server 66 (see FIG. 1) via external network 64.

Furthermore, when anomaly detector 70 detects a security anomaly, controller 72 executes a process to temporarily raise a security level of in-vehicle network 6 by restricting communication between TCU 50 and external server 66. Specifically, when anomaly detector 70 detects a security anomaly, controller 72 determines a risk level that indicates a degree of risk corresponding to the security anomaly detected. Controller 72 determines risk levels for three different levels, namely “high”, “medium”, and “low”, for example. The higher the risk level, the higher the risk of vehicle 4 being stolen or an accident or the like occurring due to unintentional control of vehicle 4, for example. Moreover, controller 72 restricts communication between TCU 50 and external server 66, in stages, according to the risk level determined.

As illustrated in FIG. 3, when the security anomaly detected by anomaly detector 70 is an “unintentional change in hardware configuration”, controller 72 determines the risk level to be “low”, for example. Here, an “unintentional change in hardware configuration” refers to at least one of zone ECU 18, zone ECU 24, zone ECU 30, zone ECU 36, or zone ECU 42 being unintentionally replaced with an ECU that has not been registered in advance, or the like, when zone ECU 18, zone ECU 24, zone ECU 30, zone ECU 36, and zone ECU 42 are configured as attachable and detachable units, for example.

In this case, controller 72 filters the plurality of vehicle information items obtained by obtainer 68 to output only specific vehicle information items among the plurality of vehicle information items to TCU 50. In other words, controller 72 only permits the specific vehicle information items among the plurality of vehicle information items to be transmitted to TCU 50. Here, the specific vehicle information items are position information and time information of vehicle 4 at the point in time when the security anomaly was detected and information related to the owner of vehicle 4, for example. Accordingly, TCU 50 transmits only the specific vehicle information items output from controller 72 to external server 66 via external network 64.

Furthermore, when the security anomaly detected by anomaly detector 70 is “unauthorized access to a non-ADAS ECU”, controller 72 determines the risk level to be “medium”, for example. Here, a “non-ADAS ECU” refers to a zone ECU other than ADAS zone ECU 18, namely, zone ECU 24, zone ECU 30, zone ECU 36, or zone ECU 42 among the plurality of zone ECUs, namely, zone ECU 18, zone ECU 24, zone ECU 30, zone ECU 36, and zone ECU 42 included in in-vehicle network 6, for example.

In this case, controller 72 outputs only a specific vehicle information item from a specific VLAN (third VLAN for example) among the plurality of vehicle information items obtained by obtainer 68 from the first VLAN, second VLAN, and third VLAN to TCU 50. In other words, controller 72 only permits the specific vehicle information items among the plurality of vehicle information items from the first VLAN, second VLAN, and third VLAN to be transmitted to TCU 50. Accordingly, TCU 50 transmits only the specific vehicle information items output from controller 72 to external server 66 via external network 64. Furthermore, controller 72 blocks communication between the first VLAN, second VLAN, and third VLAN.

Furthermore, when the security anomaly detected by anomaly detector 70 is “unauthorized access to TCU or ADAS, unauthorized physical modification”, controller 72 determines the risk level to be “high”, for example. Here, “TCU or ADAS” refers to TCU 50 or ADAS zone ECU 18.

In this case, controller 72 (i) causes vehicle 4 to transition from a state in which vehicle 4 is drivable to a state in which vehicle 4 is undrivable by deleting memory for each of zone ECU 24, zone ECU 30, zone ECU 36, and zone ECU 42, for example, or (ii) causes vehicle 4 to transition from a state in which an ignition of vehicle 4 can be turned on to a state in which the ignition of vehicle 4 cannot be turned on by stopping powertrain system zone ECU 24, for example. Accordingly, vehicle 4 can be prevented from being stolen or being driven out of control.

### 1-3. Operation of Central ECU

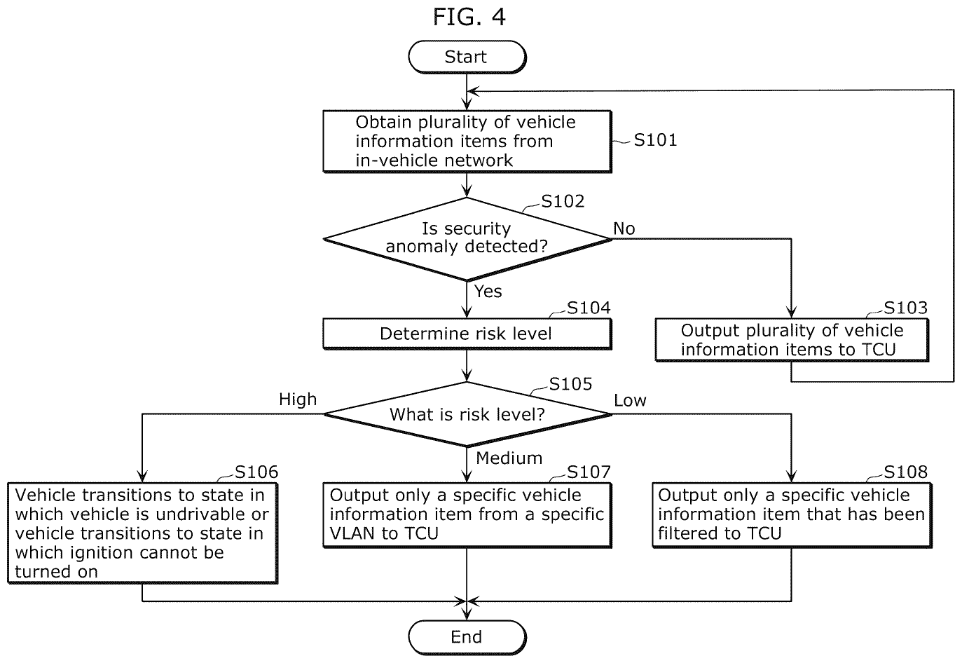

Next, operation of central ECU 48 according to Embodiment 1 will be described with reference to FIG. 4. FIG. 4 is a flowchart illustrating the flow of operation of central ECU 48 according to Embodiment 1.

As illustrated in FIG. 4, obtainer 68 first obtains a plurality of vehicle information items from each of zone ECU 18, zone ECU 24, zone ECU 30, zone ECU 36, and zone ECU 42 in in-vehicle network 6 (S101).

Next, when anomaly detector 70 does not detect a security anomaly in in-vehicle network 6 (“No” in S102) based on the plurality of vehicle information items obtained by obtainer 68, controller 72 outputs the plurality of vehicle information items obtained by obtainer 68 to TCU 50 (S103). Subsequently, processing returns to step S101.

In step S102, when anomaly detector 70 detects a security anomaly in in-vehicle network 6 (“Yes” in S102) based on the plurality of vehicle information items obtained by obtainer 68, controller 72 determines a risk level that corresponds to the security anomaly detected (S104).

When controller 72 determines that the risk level is “high” (“High” in S105), controller 72 (i) causes vehicle 4 to transition from a state in which vehicle 4 is drivable to a state in which vehicle 4 is undrivable, or (ii) causes vehicle 4 to transition from a state in which an ignition of vehicle 4 can be turned on to a state in which the ignition of vehicle 4 cannot be turned on (S106).

In step S105, when controller 72 determines that the risk level is “medium” (“Medium” in S105), controller 72 outputs only a specific vehicle information item from a specific VLAN among the plurality of vehicle information items obtained by obtainer 68 from the first VLAN, second VLAN, and third VLAN to TCU 50 (S107).

In step S105, when controller determines that the risk level is “low” (“Low” in S105), controller 72 filters the plurality of vehicle information items obtained by obtainer 68 to output only the specific vehicle information item among the plurality of vehicle information items to TCU 50 (S108).

### 1-4. Advantageous Effects

As described earlier, in the present embodiment, when anomaly detector 70 detects a security anomaly, controller 72 executes a process to temporarily raise a security level of in-vehicle network 6 by restricting communication between TCU 50 and external server 66.

Accordingly, vehicle information or the like that an attacker has tampered with can be prevented from being transmitted from TCU 50 to external server 66, for example. As a result, safety of communication between TCU 50 and external server 66 when a security anomaly is detected can be improved.

### Embodiment 2

### 2-1. Functional Configuration of Central ECU

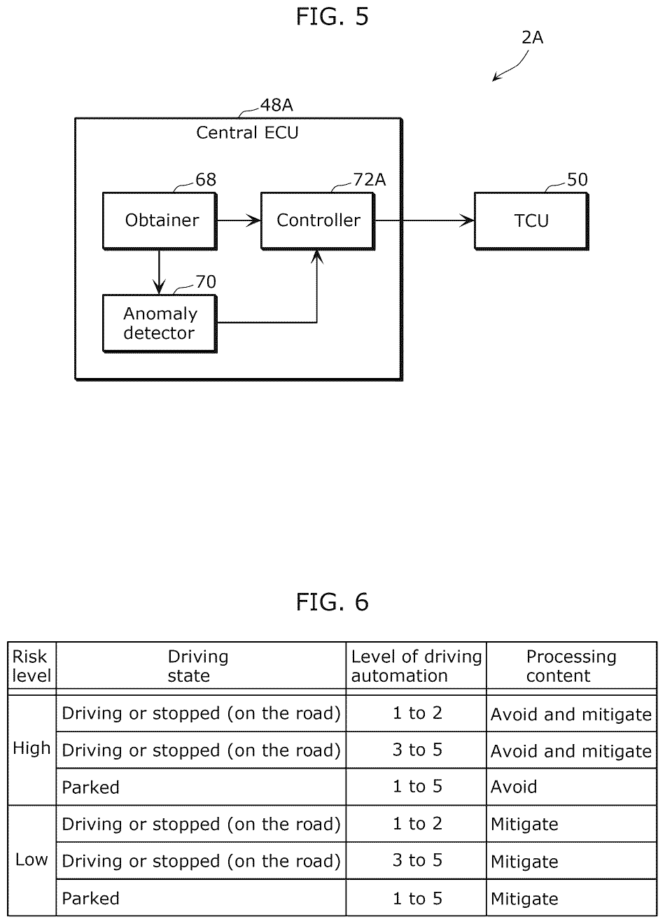

Next, a functional configuration of central ECU 48A of vehicle control system 2A according to Embodiment 2 will be described with reference to FIG. 5 and FIG. 6. FIG. 5 is a block diagram illustrating a functional configuration of central ECU 48A according to Embodiment 2. FIG. 6 is a diagram for describing an example of a function of central ECU 48A according to Embodiment 2. Note that in the present embodiment, elements that are the same as in the above-mentioned Embodiment 1 are given the same reference signs and descriptions thereof are omitted.

As illustrated in FIG. 5, in central ECU 48A of vehicle control system 2A, processes of controller 72A are different from that described in the above-mentioned Embodiment 1. Specifically, when a security anomaly is detected by anomaly detector 70, controller 72A determines a risk level corresponding to the security anomaly detected. In the present embodiment, controller 72A determines risk levels for two different levels, namely “high” and “low”, for example. A “high” risk level is a level at which there is a risk of vehicle 4 being stolen or an accident or the like occurring due to unintentional control of vehicle 4, for example. Furthermore, a “low” risk level indicates that while there is no risk of vehicle 4 being stolen or an accident or the like occurring, there is a risk that the comfort of driving or the comfort of the cabin space of vehicle 4 may be sacrificed.

Furthermore, controller 72A determines a driving state of vehicle 4 (whether vehicle is driving, stopped, parked, or the like, for example) based on vehicle information from powertrain system zone ECU 24. Furthermore, controller 72A determines a level of driving automation of vehicle 4. Here, “level of driving automation” refers to levels that correspond to the degrees of driving automation as established by the “Society of Automotive Engineers” (SAE) J3016, and these levels can be divided into 5 levels, namely, from “1” to “5”, for example. Level of driving automation 1 is “driver assistance”, level of driving automation 2 is “partial driving automation”, level of driving automation 3 is “conditional driving automation”, level of driving automation 4 is “high driving automation”, and level of driving automation 5 is “full driving automation”.

Furthermore, controller 72A determines at least one of “avoid” or “mitigate” as a processing content based on the risk level, the driving state of vehicle 4, and the level of driving automation determined. Here, “avoid” refers to the stopping of controls and functions that are risky. Furthermore, “mitigate” refers to reducing the probability that a risk will occur by enacting a predetermined measure.

As illustrated in FIG. 6, when the risk level is “high”, the driving state of vehicle 4 is “driving or stopped (on the road)”, and the level of driving automation of vehicle 4 is from “1” to “2”, controller 72A determines the processing content to be “avoid and mitigate”. In this case, controller 72A (i) restricts functions of ADAS zone ECU 18 (see FIG. 1) and (ii) controls IVI system zone ECU 42 (see FIG. 1) in order to alert the driver by voice, display, or the like to park on the side of the road, for example. Next, controller 72A (iii) causes vehicle 4 to transition from a state in which vehicle 4 is drivable to a state in which vehicle 4 is undrivable, or (iv) causes vehicle 4 to transition from a state in which the ignition of vehicle 4 can be turned on to a state in which the ignition of vehicle 4 cannot be turned on.

Furthermore, when the risk level is “high”, the driving state of vehicle 4 is “driving or stopped (on the road)”, and the level of driving automation of vehicle 4 is from “3” to “5”, controller 72A determines the processing content to be “avoid and mitigate”, for example. In this case, controller 72A (i) switches from automated driving to manual driving, or (ii) controls powertrain system zone ECU 24 and chassis system zone ECU 36 (see FIG. 1) to drive to the side of the road and park vehicle 4 by automated driving, for example.

Furthermore, when the risk level is “high”, the driving state of vehicle 4 is “parked”, and the level of driving automation of vehicle 4 is from “1” to “5”, controller 72A determines the processing content to be “avoid”, for example. In this case, controller 72A (i) causes vehicle 4 to transition from a state in which vehicle 4 is drivable to a state in which vehicle 4 is undrivable, or (ii) causes vehicle 4 to transition from a state in which the ignition of vehicle 4 can be turned on to a state in which the ignition of vehicle 4 cannot be turned on, for example.

Furthermore, when the risk level is “low”, the driving state of vehicle 4 “driving or stopped (on the road)”, and the level of driving automation of vehicle 4 is from “1” to “2”, controller 72A determines the processing content to be “mitigate”, for example. In this case, controller 72A controls IVI system zone ECU 42 so as to alert the driver by voice or display, for example. It should be noted that the alert presented to the driver includes an indication that a security anomaly has occurred, or guidance to a car dealership or the like using navigation device 44 (see FIG. 1), for example.

Furthermore, when the risk level is “low”, the driving state of vehicle 4 “driving or stopped (on the road)”, and the level of driving automation of vehicle 4 is from “3” to “5”, controller 72A determines the processing content to be “mitigate”, for example. In this case, controller 72A controls IVI system zone ECU 42 so as to alert the driver by voice or display, for example. It should be noted that the alert presented to the driver includes an indication that a security anomaly has occurred, or guidance to a car dealership or the like using navigation device 44 (see FIG. 1), for example.

Furthermore, when the risk level is “low”, the driving state of vehicle 4 is “parked”, and the level of driving automation of vehicle 4 is “1” to “5”, controller 72A determines the processing content to be “mitigate”. In this case, controller 72A controls IVI system zone ECU 42 so as to alert the driver by voice or display, for example. It should be noted that the alert presented to the driver includes an indication that a security anomaly has occurred, or guidance to a car dealership or the like using navigation device 44 (see FIG. 1), for example.

In the present embodiment, although controller 72A determines the processing content to be one of “avoid” or “mitigate” as the processing content, this example is non-limiting, and controller 72A may determine the processing content to be one of “avoid”, “mitigate”, or “accept”. Here, “accept” refers to the act of accepting the risk and not executing any processes.

### 2-2. Operation of Central ECU

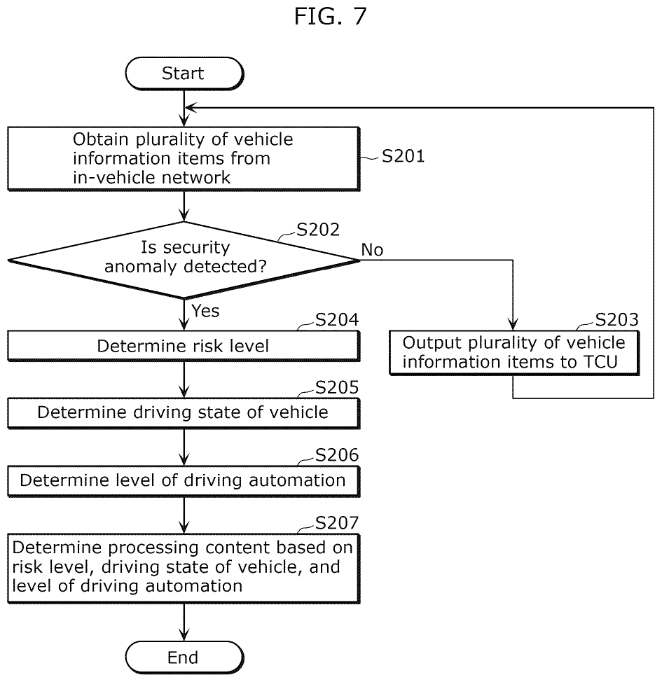

Next, operation of central ECU 48A according to Embodiment 2 will be described with reference to FIG. 7. FIG. 7 is a flowchart illustrating the flow of operation of central ECU 48A according to Embodiment 2.

As illustrated in FIG. 7, step S201 through step S204 are performed in the same manner as step S101 through step S104 in FIG. 4 described in the above-mentioned Embodiment 1.

After step S204, controller 72A determines the driving state of vehicle 4 (S205), and next, controller 72A determines the level of driving automation of vehicle 4 (S206).

Next, controller 72A determines at least one of “avoid” or “mitigate” to be the processing content based on the risk level determined in step S204, the driving state of vehicle 4 determined in step S205, and the level of driving automation of vehicle 4 determined in step S206 (S207).

### 2-3. Advantageous Effects

As described earlier, in the present embodiment, controller 72A determines at least one of “avoid” or “mitigate” to be the processing content based on the risk level, the driving state of vehicle 4, and the level of driving automation of vehicle 4. Accordingly, appropriate processing content can be determined in accordance with the traffic conditions in the surroundings of vehicle 4.

### Other Variations

While a vehicle control system and a control method according to one or more aspects have been described based on the above-mentioned embodiments, the present disclosure is not limited to the above-mentioned embodiments. Forms obtained by various modifications to the foregoing embodiments conceivable by those skilled in the art or forms obtained by combining elements in different embodiments, so long as they do not depart from the essence of the present disclosure, may be included in the one or more aspects.

In the above-mentioned embodiments, each element may be configured as dedicated hardware, or may be implemented by executing a computer program suitable for each element. Each element may be implemented by a program executor, such as a central processing unit (CPU) or a processor or the like reading and executing a computer program recorded on a recording medium, such as a hard disk or a semiconductor memory or the like.

Furthermore, a portion or all of the functions of the vehicle control system according to the above-mentioned embodiments may be implemented by a processor, such as a CPU, executing a computer program.

A portion or all of the elements included in the preceding devices may be configured as an ECU or stand-alone module that can be inserted and removed from the corresponding device. The ECU or the module is a computer system that includes a microprocessor, ROM, RAM, and the like. The ECU or the module may include a super-multifunctional large scale integration (LSI). The microprocessor operates according to the computer program, so that a function of the ECU or the module is achieved. The ECU or the module may be tamper-resistant.

The present disclosure may be a method described above. Furthermore, the present disclosure may be a computer program for causing a computer to execute the method, or may be a digital signal of the computer program. Additionally, the present disclosure may be the above-mentioned computer program or the digital signal recorded on a non-transitory, computer-readable recording medium, such as a flexible disk, hard disk, CD-ROM, MO, DVD, DVD-ROM, DVD-RAM, BD (Blu-ray (registered trademark) Disc), or semiconductor memory. Moreover, the present disclosure may be the digital signal recorded on the above-mentioned recording medium. Furthermore, the present disclosure may be the above-mentioned computer program or the digital signal transmitted via an electric communication line, a wireless or wired communication line, a network, such as the Internet, data broadcasting, and the like. Additionally, the present disclosure may be a computer system including a microprocessor and memory. The memory may store the above-mentioned computer program, and the microprocessor may operate according to the computer program. Moreover, by transferring the recording medium having the above-mentioned program or digital signal recorded thereon or by transferring the above-mentioned program or digital signal via the above-mentioned network or the like, the present disclosure may be implemented by a different independent computer system.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2023-220784 filed on Dec. 27, 2023.

### Industrial Applicability

The vehicle control system according to the present disclosure can be applied to a security system or the like for monitoring an in-vehicle network provided in a vehicle, for example.

1. A vehicle control system that establishes an in-vehicle network provided in a vehicle, the vehicle control system comprising:
an obtainer that obtains vehicle information on the vehicle from the in-vehicle network;
a communicator that is capable of communicating with an external device via an external network and transmits the vehicle information obtained by the obtainer to the external device via the external network;
an anomaly detector that detects a security anomaly in the in-vehicle network; and
a controller that restricts communication between the communicator and the external device when the security anomaly is detected by the anomaly detector.

2. The vehicle control system according to claim 1, wherein
when the security anomaly is detected by the anomaly detector, the controller filters a plurality of vehicle information items obtained by the obtainer to output, to the communicator, a specific vehicle information item among the plurality of vehicle information items, the plurality of vehicle information items each being the vehicle information, and
the communicator transmits the specific vehicle information item output from the controller to the external device via the external network.

3. The vehicle control system according to claim 1, wherein
the in-vehicle network is virtually divided into a plurality of virtual local area networks (VLANs),
when the security anomaly is detected by the anomaly detector, the controller outputs, to the communicator, a specific vehicle information item from a specific VLAN among a plurality of vehicle information items from the plurality of VLANs obtained by the obtainer, the plurality of vehicle information items each being the vehicle information, and
the communicator transmits the specific vehicle information item output from the controller to the external device via the external network.

4. The vehicle control system according to claim 1, wherein
when the security anomaly is detected by the anomaly detector, the controller determines a risk level indicating a degree of risk corresponding to the security anomaly detected, and restricts communication between the communicator and the external device, in stages, in accordance with the risk level determined.

5. The vehicle control system according to claim 1, wherein
when a security anomaly caused by an unauthorized physical modification of the in-vehicle network is detected by the anomaly detector, the controller further (i) causes the vehicle to transition from a state in which the vehicle is drivable to a state in which the vehicle is undrivable or (ii) causes the vehicle to transition from a state in which an ignition can be turned on to a state in which the ignition cannot be turned on.

6. A control method in a vehicle control system that establishes an in-vehicle network provided in a vehicle, the control method comprising:
(a) obtaining vehicle information on the vehicle from the in-vehicle network;
(b) transmitting the vehicle information obtained in (a) from a communicator of the vehicle control system to an external device via an external network;
(c) detecting a security anomaly in the in-vehicle network; and
(d) restricting communication between the communicator and the external device when the security anomaly is detected in (c).
